(19) United States
(12) Patent Application Publication
(10) Pub. No.: US 2013/0269342 A1
(43) Pub. Date: Oct. 17, 2013

(54) TURBOCHARGER OF ENGINE

(71) Applicant: Hyundai Motor Company, (US)

(72) Inventors: Wan Soo Oh, Yongin-si (KR); Heung Seok Lee, Seoul (KR); Yong Wook Jin, Suwon-si (KR); Jae Woong Hwang, Yongin-si (KR)

(73) Assignee: Hyundai Motor Company, Seoul (KR)

(21) Appl. No.: 13/665,532

(22) Filed: Oct. 31, 2012

(30) Foreign Application Priority Data
Apr. 12, 2012 (KR) 10-2012-0037972

(51) Int. Cl. F02B 33/00

(52) U.S. Cl. CPC F02B 33/00
USPC 60/607; 60/273

(57) ABSTRACT

A turbocharger apparatus of an engine may include a turbine installed to generate a rotating force from an exhaust gas flow of the engine, a compressor selectively coupled to the turbine to be rotated for compressing air which is to be supplied into an engine combustion chamber of the engine, a shaft installed to transfer the rotating force of the turbine to the compressor, a clutch installed to the shaft to control the transfer of the rotating force between the turbine and the compressor, a planetary gear unit connected to the compressor, and a motor generator mounted onto the shaft and coupled to the planetary gear unit to receive the rotating force of the compressor through the planetary gear set.

### CROSS-REFERENCE TO RELATED APPLICATION

The present application claims priority to Korean Patent Application No. 10-2012-0037972, filed on Apr. 12, 2012, the entire contents of which is incorporated herein for all purposes by this reference.

### BACKGROUND OF THE INVENTION

1. Field of the Invention

The present disclosure relates to a turbocharger of an engine. More particularly, it relates to a technology regarding a turbocharger for supercharging intake air by using exhaust gas of an engine.

2. Description of Related Art

Turbochargers adapted to suction more air into a combustion chamber of an engine to improve an output of the engine have been used until now, and since such turbochargers pressurizes suction air by using energy of exhaust gas discharged from an engine, their responses are accompanied by turbo lags and thus are basically slow.

Various existing measures such as twin turbo or sequential turbo have been suggested to cope with such turbo lags, which makes structure and control complex and significantly increases manufacturing costs.

Moreover, only one turbocharger cannot guarantee an optimized operation in an entire operation region of an engine, and an ordinary driver mainly uses a low-speed operation region, but since high emphasis is put mainly on high-output characteristics of engines when turbochargers are designed, low-speed torques of the engines become insufficient, making it impossible to sufficiently cope with needs of consumers.

It is noted that the above-mentioned technology is only for the purpose of improving understanding of the background of the present invention, but should not be construed to admit that it is already well known to one of ordinary skill in the art to which the present invention pertains.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a supercharging apparatus of an engine which can improve a low-speed torque of an engine and significantly reduce a turbo lag, thereby reducing costs due to relatively simple structure and control thereof while securing a smooth operation such as improvement of hill climbing ability of a vehicle due to a quick response and a high low-speed torque.

In an aspect of the present invention, a turbocharger apparatus of an engine may include a turbine installed to generate a rotating force from an exhaust gas flow of the engine, a compressor selectively coupled to the turbine to be rotated for compressing air which is to be supplied into an engine combustion chamber of the engine, a shaft installed to transfer the rotating force of the turbine to the compressor, a clutch installed to the shaft to control the transfer of the rotating force between the turbine and the compressor, a planetary gear unit connected to the compressor, and a motor generator mounted onto the shaft and coupled to the planetary gear unit to receive the rotating force of the compressor through the planetary gear set.

The planetary gear unit may include a simple planetary gear set having a sun gear, a carrier, and a ring gear, wherein the sun gear is connected to the shaft, the carrier is connected to the compressor, and the ring gear is connected to a rotor of the motor generator.

The turbocharger apparatus may further include a one-way clutch configured to allow the shaft to be rotated in a same direction as a rotating direction of the compressor, and restrict rotation of the shaft in an opposite rotating direction.

The clutch is installed to the shaft to control a rotating force between the sun gear of the planetary gear unit and the turbine.

In another aspect of the present invention, a method of controlling a turbocharger apparatus of an engine, in which a shaft connecting a turbine and a compressor is controlled by a clutch, and a motor generator, the shaft, and the compressor are connected by a planetary gear unit such that the compressor is driven by all or one of the turbine and the motor generator, may include dividing an operation of the compressor into a plurality of modes where the compressor is driven by all or one of the turbine and the motor generator according to a manipulation amount of an accelerator pedal, an RPM of the engine, a suction gas pressure, an exhaust gas pressure, and a speed of a vehicle.

A supercharging apparatus of an engine can improve a low-speed torque of an engine and significantly reduce a turbo lag, thereby reducing costs due to relatively simple structure and control thereof while securing a smooth operation such as improvement of hill climbing ability of a vehicle due to a quick response and a high low-speed torque.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a turbocharger of an engine according to an exemplary embodiment of the present invention.

FIG. 2 is a view for explaining an operation of the turbocharger of the present invention in a low-speed operation region of the engine.

FIG. 3 is a graph for comparing rotating speeds of rotation bodies according to the operation of FIG. 2.

FIG. 4 is a view for explaining an operation of the turbocharger of the present invention in a middle-speed operation region of the engine.

FIG. 5 is a graph for comparing rotating speeds of rotation bodies according to the operation of FIG. 4.

FIG. 6 is a view for explaining an operation of the turbocharger of the present invention in a high-speed operation region of the engine.

FIG. 7 is a graph for comparing rotating speeds of rotation bodies according to the operation of FIG. 6.

FIG. 8 is a flowchart for explaining a control example of the turbocharger according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

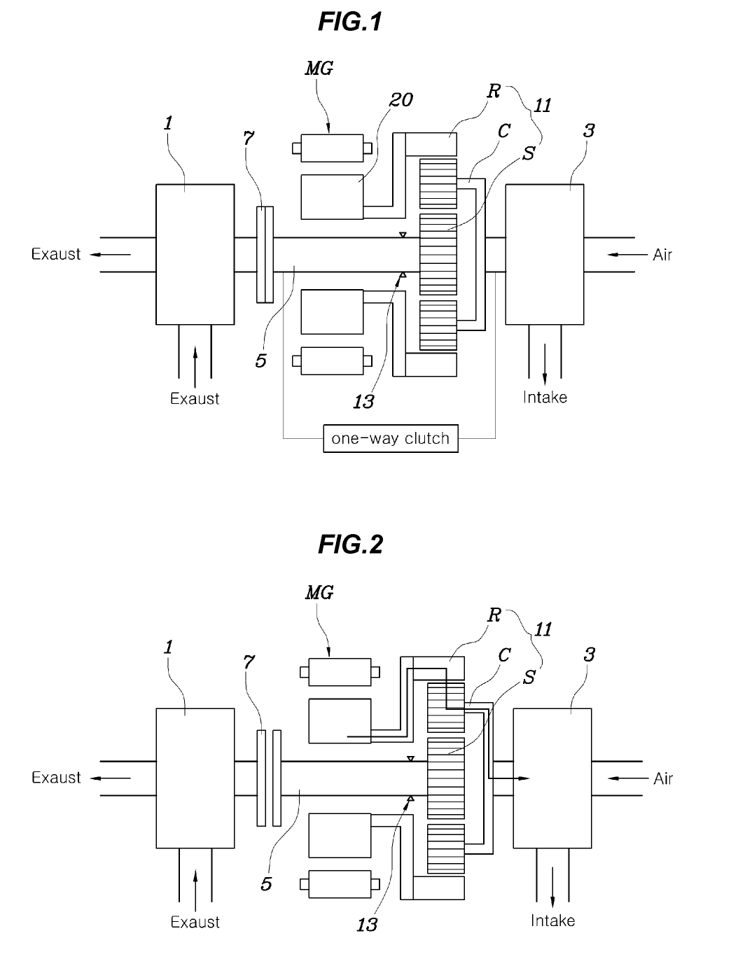

Referring to FIG. 1, a turbocharger of an engine according to an exemplary embodiment of the present invention includes: a turbine 1 installed to produce a rotating force from an exhaust gas flow of an engine, a compressor 3 installed to be rotated for compressing air which is to be supplied into an engine combustion chamber, a shaft 5 installed to transfer the rotating force of the turbine 1 to the compressor 3, a clutch 7 installed to interrupt the transfer of the rotating force between the turbine 1 and the compressor 3, a motor generator MG installed to receive the rotating force from the compressor 3, and a planetary gear unit 11, rotation elements of which are connected to the motor generator MG, the shaft 5, and the compressor 3, respectively.

That is, the clutch 7 interrupts a connection between the turbine 1 and the compressor 3 instead of using a structure of directly connecting a turbine and a compressor through a shaft according to the related art, and the compressor 3 is configured to be driven independently from the turbine 1 by using the motor generator MG and the planetary gear unit 11.

The planetary gear unit 11 includes a simple planetary gear set including a sun gear S, a carrier C, and a ring gear R. The sun gear S is connected to the shaft 5, the carrier C is connected to the compressor 3, and the ring gear R is connected to a rotor 20 of the motor generator MG.

The turbocharger further includes a one-way clutch configured to allow the shaft 5 to be rotated in a same direction as a rotating direction of the compressor 3, and restrict rotation of the shaft 5 in an opposite rotating direction.

In the exemplary embodiment, the clutch 7 is installed to interrupt a rotating force between the sun gear S of the planetary gear unit 11 and the turbine 1.

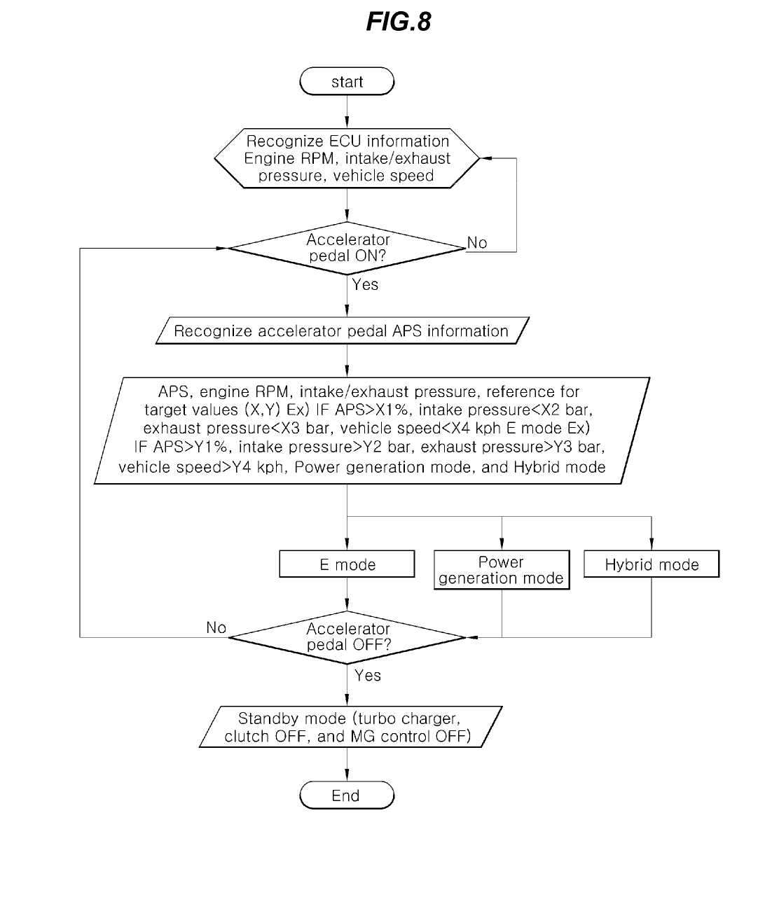

The above-configured turbocharger of the engine of the present invention can be operated in various modes illustrated in FIGS. 2, 4, and 6, and such operation control is exemplified in FIG. 8.

FIG. 2 represents an E mode which can be implemented when an engine is idling or coasting at a low speed. In Mode E, since the clutch 7 is released, a rotating force of the turbine 1 is not transferred to the compressor 3 through the shaft 5.

For example, if a drive starts to push down an accelerator pedal during coasting, the ring gear R is driven by the motor generator MG while the clutch 7 is released. Since reverse rotation of the shaft 5 is restrained by the one-way clutch 13, the carrier C is rotated while reducing a rotating force of the motor generator MG. As a result, the compressor 3 is driven to compress and supercharge air supplied into the combustion chamber.

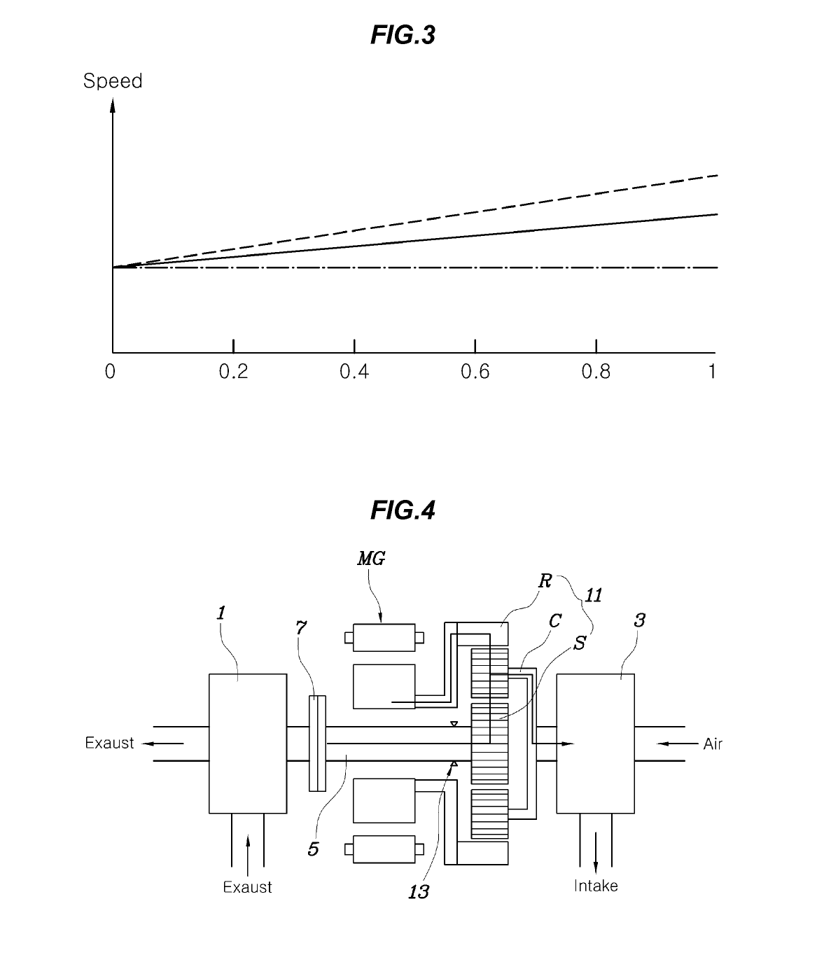

Referring to the graph of FIG. 3 to describe the above-described state, even when the turbine 1 indicated by an alternate long and short dash line is rotated at a constant speed due to flow of exhaust gas, if the compressor 3 is driven through the planetary gear unit 11 while the motor generator MG indicated by a dotted line is rotating, a speed of the compressor 3 indicated by a solid line is reduced further than a rotating speed of a rotor 20 of the motor generator MG but is rapidly accelerated separately from the turbine 1, which improves an output of the engine due to a suitable supercharging function.

The above-described operation solves an existing low-speed torque problem of the compressor 3 not being able to perform a supercharging operation promptly and sufficiently due to exhaust gas without sufficient energy during a low-speed operation of the engine and such problems as a turbo lag.

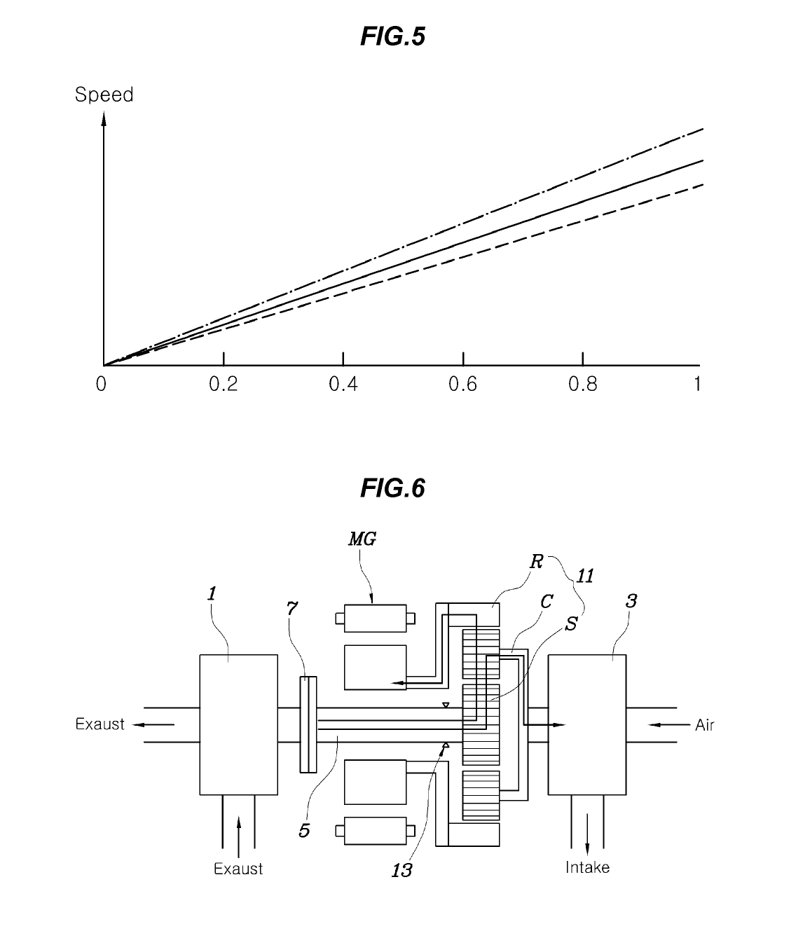

FIGS. 4 and 5 represent a hybrid mode which can be used in a situation where an engine is operated at a middle speed. In the hybrid mode, through connection of the clutch 7, a rotating force of the turbine 1 is transferred to the sun gear S via the shaft 5, a rotating force of the motor generator MG is transferred to the ring gear R, and the compressor 3 connected to the carrier C smoothly performs a supercharging operation.

In this mode, even when a size of the turbine 1 is large, the turbine 1 can be promptly accelerated by assistance of power of the motor generator MG.

Of course, when a rotating speed of the turbine 1 is sufficient, an operation mode similar to that of an existing general turbo charger which does not drive the motor generator MG and drives the compressor 3 only with a rotating force of the turbine 1 while providing the ring gear R only with a repulsive force may be implemented.

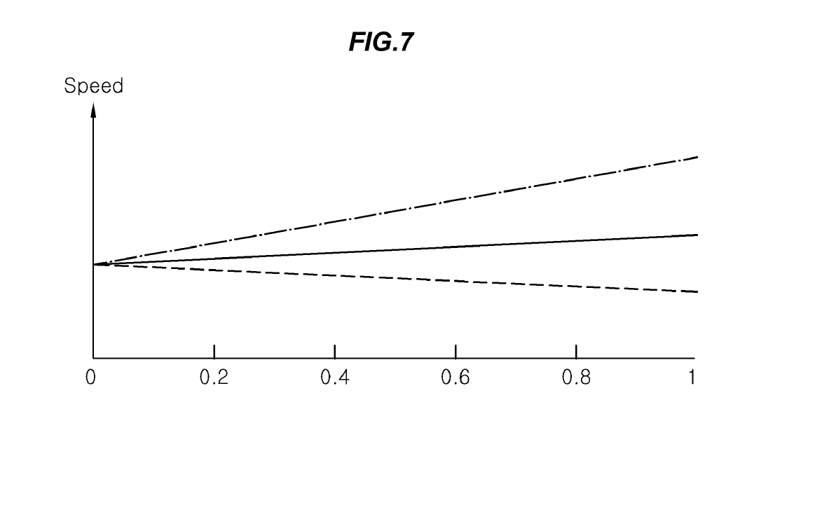

FIGS. 6 and 7 represent a power generation mode in which an engine is operated at a sufficiently high speed. In this case, since a rotating force of the turbine 1 is equal to or greater than a rotating force required by the compressor 3, power assistance of the motor generator MG is not necessary further but the motor generator MG can be driven by the rotating force of the turbine 1 to generate electricity.

Of course, an operation speed of the compressor 3 can be controlled independently from the turbine 1 by controlling an amount of power generated by the motor generator MG.

FIG. 8 illustrates an example of controlling the supercharging apparatus according to an exemplary embodiment of the present invention. The control of the supercharging apparatus is basically controlled by manipulating an accelerator pedal, and one of the E mode, the power generation mode, and the hybrid mode can be selected according to a preset condition which considers an RPM of the engine, a suction pressure, an exhaust pressure, and a speed of the vehicle, in addition to a manipulation amount of the accelerator pedal.

That is, in this example, when the accelerator pedal is turned on while continuously receiving information regarding an RPM of the engine, a suction pressure, an exhaust pressure, and a speed of the vehicle, the control unit recognizes a manipulation amount of the accelerator pedal, determines whether or not the manipulation amount of the accelerator pedal, the RPM of the engine, the suction pressure, the exhaust pressure, and the speed of the vehicle are within reference ranges exemplified in FIG. 8, selects one of the E mode, the power generation mode, and the hybrid mode, and accordingly, implements the corresponding mode by using the clutch 7 and the motor generator MG. In contrast, if the accelerator pedal is turned off, the control is completed and the mode is converted into a standby mode.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbocharger apparatus of an engine, comprising:
a turbine installed to generate a rotating force from an exhaust gas flow of the engine;
a compressor selectively coupled to the turbine to be rotated for compressing air which is to be supplied into an engine combustion chamber of the engine;
a shaft installed to transfer the rotating force of the turbine to the compressor;
a clutch installed to the shaft to control the transfer of the rotating force between the turbine and the compressor;
a planetary gear unit connected to the compressor; and
a motor generator mounted onto the shaft and coupled to the planetary gear unit to receive the rotating force of the compressor through the planetary gear set.

2. The turbocharger apparatus of claim 1,
wherein the planetary gear unit includes a simple planetary gear set having a sun gear, a carrier, and a ring gear, and
wherein the sun gear is connected to the shaft, the carrier is connected to the compressor, and the ring gear is connected to a rotor of the motor generator.

3. The turbocharger apparatus of claim 2, further including a one-way clutch configured to allow the shaft to be rotated in a same direction as a rotating direction of the compressor, and restrict rotation of the shaft in an opposite rotating direction.

4. The turbocharger apparatus of claim 2, wherein the clutch is installed to the shaft to control a rotating force between the sun gear of the planetary gear unit and the turbine.

5. A method of controlling a turbocharger apparatus of an engine, in which a shaft connecting a turbine and a compressor is controlled by a clutch, and a motor generator, the shaft, and the compressor are connected by a planetary gear unit such that the compressor is driven by all or one of the turbine and the motor generator, the method comprising:
dividing an operation of the compressor into a plurality of modes where the compressor is driven by all or one of the turbine and the motor generator according to a manipulation amount of an accelerator pedal, an RPM of the engine, a suction gas pressure, an exhaust gas pressure, and a speed of a vehicle.
